(19) United States
(12) Patent Application Publication
(10) Pub. No.: US 2019/0017298 A1
(43) Pub. Date: Jan. 17, 2019

(54) VEHICULAR LATCH ASSEMBLY WITH OPTIMIZED SEALING

(71) Applicant: MAGNA CLOSURES INC., Newmarket (CA)

(72) Inventors: Dunia SARDELLI, Livorno (IT); Francesco CUMBO, Pisa (IT)

(21) Appl. No.: 16/034,420

(22) Filed: Jul. 13, 2018

Related U.S. Application Data
(60) Provisional application No. 62/533,220, filed on Jul. 17, 2017.

(51) Int. Cl. E05B 77/34; E05B 79/20; E05B 85/02

(52) U.S. Cl. CPC E05B 77/34; E05B 85/02; E05B 79/20

(57) ABSTRACT

A sealed latch assembly for a vehicle closure panel is provided. The latch assembly includes a housing having an internal cavity sized for receipt of internal components of the latch assembly. A cover is attached to the housing to enclose at least a portion of the internal cavity. At least one release cable is configured for operable connection to at least one of the internal components. A water shield is attached to the cover. The water shield has at least one opening sized for receipt of the release cable therethrough. At least one seal member is configured to form a water-tight seal between the housing and the cover and/or between the water shield and the cover and/or between the at least one opening and the at least one release cable.

### CROSS-REFERENCE TO RELATED APPLICATION

This application claims the benefit of U.S. Provisional Application Ser. No. 62/533,220, filed Jul. 17, 2017, which is incorporated herein by reference in its entirety.

### FIELD

The present disclosure relates generally to latch assemblies of vehicle closure panels, and more particularly to latch assemblies having seal members to inhibit water ingress.

### BACKGROUND

This section provides background information related to the present disclosure that is not necessarily prior art.

Vehicle doors are typically equipped with a latch assembly configured to allow selective opening and closing of the door. Latch assemblies commonly have multiple components assembled to one another, such as a housing and cover having peripheries brought into mating abutment with one another, as well as a multiple functional internal components contained within the housing/cover assembly. Further, openings are typically formed in the housing and/or cover to allow for the through passage of one or more members, such as electrical wires or Bowden cables for example, for operable connection to one or more of the functional internal components.

Problems can arise if water is permitted to enter the latch assembly. For example, the ingress of water can cause corrosion, and if allowed to freeze, can damage and/or jam internal components, thereby preventing internal components from functioning as intended. Unfortunately, seams and/or gaps, through which water can penetrate, are established where the housing and cover interface with one another, as well as between openings and wires/cables passing therethrough, and thus, potential damage and jamming may occur as a result thereof. The aforementioned problem can be particularly troublesome for latch assembly arrangements having openings in an upper surface (facing upwardly relative to a ground surface) for the passage of cables and/or wires, as gravity ultimately promotes the ingress of water therethrough. For example, latch assemblies configured for actuation via bowden cables often have openings in the housing and/or cover to allow the bowden cables to extend into the latch to interact with the internal components. Although needed, these openings can present an entry point for water ingress, i.e. from water which may flow along the surface of the bowden cable into the latch assembly, or from water which may be on the surface of the latch assembly adjacent to such openings and creep, for example under the force of gravity, into the latch assembly. The ingress of water can be problematic, as discussed above, especially when the bowden cable is pulled from the top of the latch assembly and if the key cylinder connection is operable via a push/pull cable. Furthermore, while preassembly of the latch, with the bowden cables pre-sealed within the latch, before completion of the latch assembly and shipment to an installer of the latch assembly to a door panel could be undertaken, such preassembly is expensive both from a logistical shipping point of view (having to ship a larger assembled component for example) and from an assembly line point of view (having to handle larger assembly components for example) and from a final inspection testing complexity point of view (the connections between the bowden cables and the latch made during preassembly have to be verified).

### SUMMARY

This section provides a general summary of the disclosure and is not intended to be considered a complete and comprehensive listing of the disclosure's full scope or all of its aspects, advantages, objectives and/or features.

It is an object of the present disclosure to provide a sealed latch assembly that inhibits the ingress of water into an internal cavity containing latch components, thereby preventing jamming due to freezing and inhibiting the onset of corrosion.

It is a further object of the present disclosure to provide a latch assembly having one or more seal members to inhibit the ingress of water between an interface of a housing and cover of the latch assembly.

It is a further object of the present disclosure to provide a latch assembly having one or more seal members to inhibit the ingress of water between openings in the housing and/or cover and wires and/or cables passing therethrough.

It is a further object of the present disclosure to provide a sealed latch assembly that is economical in manufacture, shipping and assembly.

It is a further object of the present disclosure to provide a sealed latch assembly that exhibits a long and useful life.

In accordance with these objectives, as well as others, which will be appreciated by those possessing ordinary skill in the art, the present disclosure is directed to providing a sealed latch assembly for a vehicle closure panel. The sealed latch assembly includes a housing having an internal cavity sized for receipt of internal latch components of the latch assembly. Further, a cover is attached to the housing to enclose at least a portion of the internal cavity. At least one release cable is configured for operable connection to at least one of the internal components to effect actuation of the latch assembly. Further, a water shield is attached to the cover. The water shield has at least one opening sized for receipt of an individual release cable therethrough. Further, at least one seal member is configured to form a water-tight seal between the housing and the cover and/or between the water shield and the cover and/or between the at least one opening and the at least one release cable.

In accordance with a further aspect of the disclosure, the latch assembly can include a first seal member that provides a water tight seal between the housing and the cover. The first seal member can be attached to one of the housing and the cover, and the other of the housing and the cover can have a raised seal bead brought into compressed engagement with the first seal member to perfect a fluid-tight seal therebetween.

In accordance with a further aspect of the disclosure, the latch assembly can include a second seal member that provides a water tight seal between the water shield and the cover. The second seal member can be attached to one of the water shield and the cover, and the other of the water shield and the cover can have a raised seal bead brought into compressed engagement with the second seal member to perfect a fluid-tight seal therebetween.

In accordance with a further aspect of the disclosure, one of the cover and the water shield can be provided with a cam surface and the other of the cover and the water shield can be provided with a detent, wherein the cam surface and the detent are configured to bring at least a portion of the raised seal bead into compressed engagement with the second seal member.

In accordance with a further aspect of the disclosure, the cam surface and the detent can each have at least one lead-in surface to facilitate bringing the raised seal bead into compressed engagement with the second seal member.

In accordance with a further aspect of the disclosure, the latch assembly can include a third seal member that provides a water tight seal between the at least one opening and the at least one release cable.

In accordance with a further aspect of the disclosure, the third seal member can be provided as an annular member having a through bore sized for an interference fit about the at least one release cable and sized for an interference fit about an opening in the water shield.

In accordance with a further aspect of the disclosure, a vehicle closure panel having a closure latch assembly is provided. The closure latch assembly of the vehicle closure panel includes a housing having an internal cavity configured for receipt of internal latch components and a cover attached to the housing to enclose at least a portion of the internal cavity. At least one release cable is configured for operable connection to at least one of the internal latch components. A water shield is attached to the cover, wherein the water shield has at least one opening sized for receipt of the at least one release cable therethrough. At least one seal member is configured to form a water-tight seal between at least one of the housing and the cover, the water shield and the cover, and the at least one opening and the at least one release cable.

In accordance with a further aspect of the disclosure, the closure latch assembly of the vehicle closure panel can include a first seal member that provides a water tight seal between the housing and the cover, a second seal member that provides a water tight seal between the water shield and the cover, and a third seal member that provides a water tight seal between the at least one opening and the at least one release cable.

In accordance with a further aspect of the disclosure, the first seal member of the closure latch assembly of the vehicle closure panel is attached to one of the housing and the cover, and the other of the housing and the cover has a raised seal bead brought into slidingly compressed engagement with the first seal member.

In accordance with a further aspect of the disclosure, the second seal member of the closure latch assembly of the vehicle closure panel is attached to one of the water shield and the cover, and the other of the water shield and the cover has a raised seal bead brought into compressed engagement with the second seal member.

In accordance with a further aspect of the disclosure, the third seal member of the closure latch assembly of the vehicle closure panel is an annular member having a through bore sized for an interference fit about the at least one release cable and sized for an interference fit with an opening in the water shield.

In accordance with a further aspect of the disclosure, one of the cover and the water shield of the closure latch assembly of the vehicle closure panel has a cam surface and the other of the cover and the water shield has a detent, wherein the cam surface and the detent are configured to bring at least a portion of the raised seal bead into slidingly compressed engagement with the second seal member.

Further areas of applicability will become apparent from the detailed description provided herein. The description and specific examples provided in this summary are intended for purposes of illustration only and are not intended to limit the scope of the present disclosure.

### BRIEF DESCRIPTION OF THE DRAWINGS

Other aspects and advantages of the present non-limiting embodiments will be readily appreciated, as the same becomes better understood by reference to the following detailed description and appended claims when considered in connection with the accompanying drawings, wherein:

FIG. 1 is a partial perspective view of a motor vehicle equipped with a pivotal passenger-entry door having a door handle operably interconnected to a latch assembly constructed in accordance with and embodying the teachings of the present disclosure;

FIG. 2 is a plan view of the latch shown in FIG. 1 with a portion of a housing of the latch omitted and showing a secondary pawl locking position;

FIG. 3 is a plan view of the latch shown in FIG. 2 in a secondary pawl release position;

FIG. 4 is a perspective view of the latch assembly of FIG. 1;

FIG. 4A is a view similar to FIG. 4 showing a water shield of the latch assembly in transparency;

FIG. 4B is a top pre-assembled view of the latch assembly of FIG. 4 showing the cables in an assembled position with the internal latch components, and the water shield and sealing members in slidably mounted preassembled position to the cables;

FIG. 5 is another perspective view of the latch assembly of FIG. 1 looking generally along the direction of arrow 5 of FIG. 4;

FIG. 5A is a view similar to FIG. 5 shown prior to assembly of a seal member about a striker receptacle;

FIG. 6 is an interior plan view of the cover of the latch assembly of FIG. 1;

FIG. 7 is an interior plan view of the housing of the latch assembly of FIG. 1;

FIG. 8 is a partial perspective view of the latch assembly of FIG. 1 showing sealing members of Bowden cables in transparency; and

FIGS. 9A-9D are enlarged fragmentary views looking generally along directions of respective arrows of FIG. 4A showing various sealing features of the latch assembly of FIG. 1.

Corresponding reference numerals indicate corresponding components throughout the several views of the drawings, unless otherwise indicated.

### DETAILED DESCRIPTION OF THE EXAMPLE EMBODIMENTS

In general, example embodiments of lockable release cable assemblies of the type configured for use with motor vehicle closure systems, constructed in accordance with the teachings of the present disclosure, will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

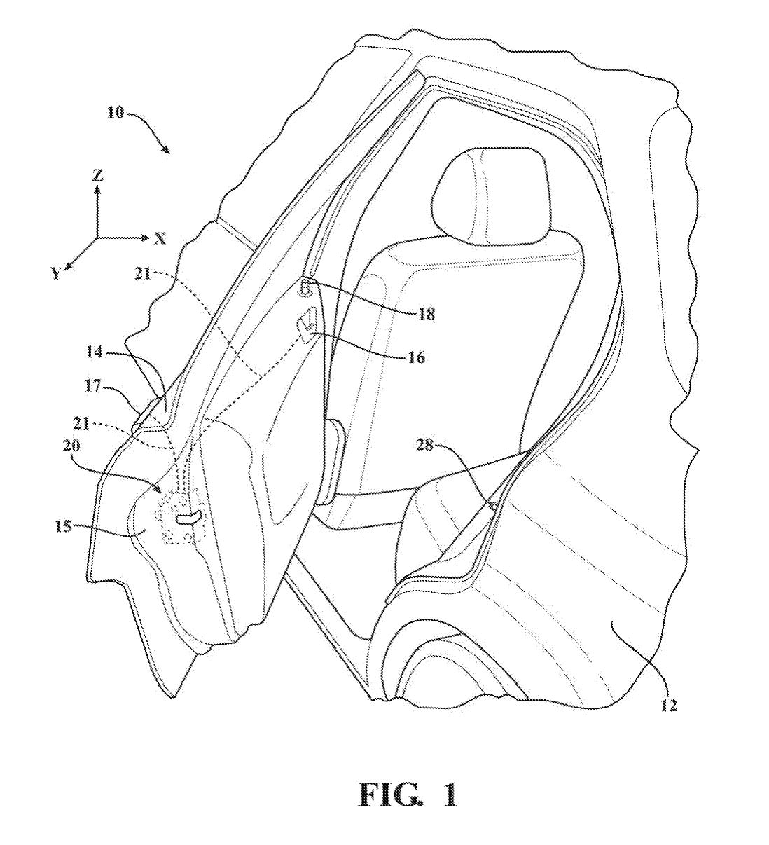

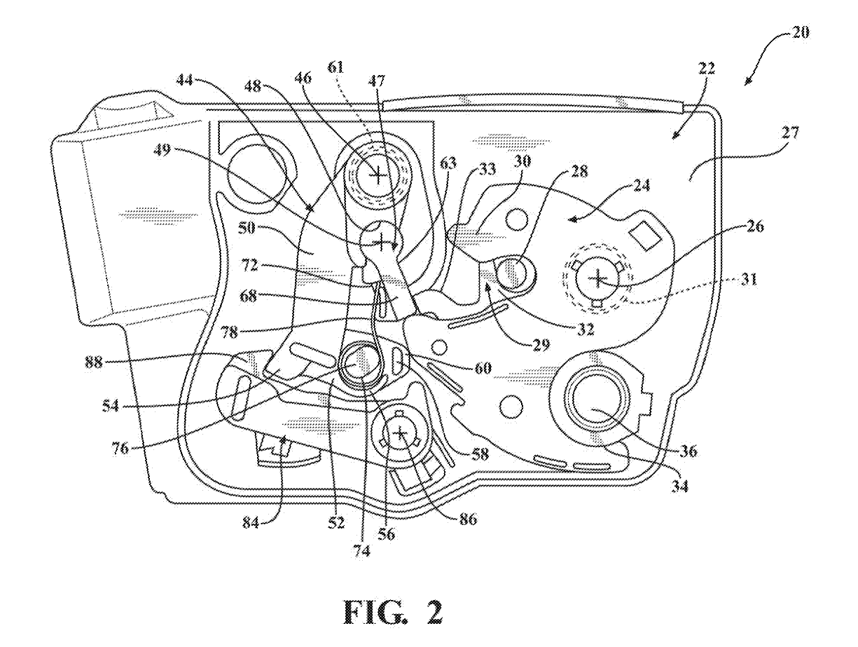

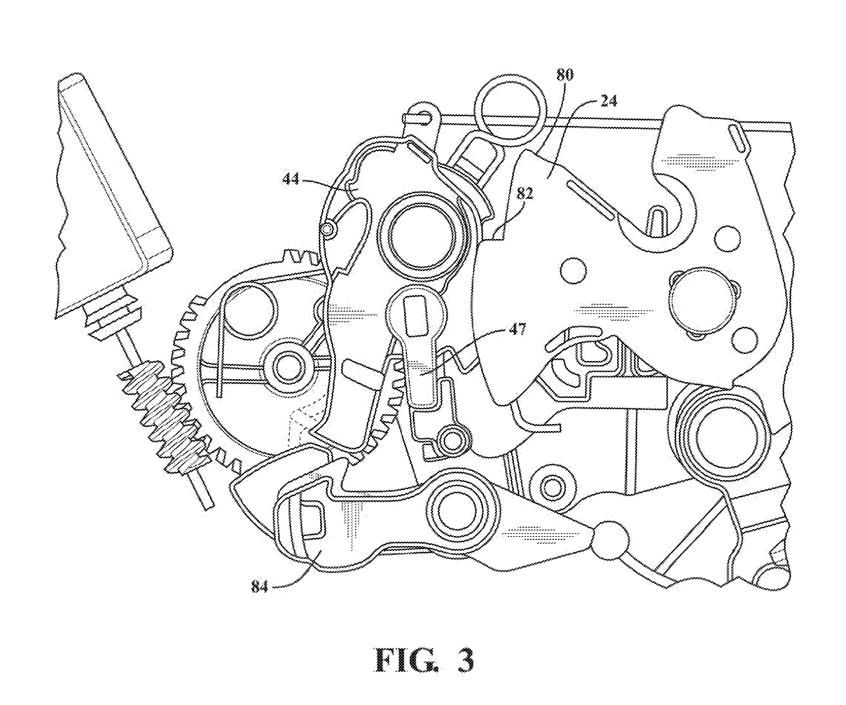

FIG. 1 is a perspective view of a vehicle 10 that includes a vehicle body 12 and at least one vehicle closure panel, shown as a vehicle door 14, by way of example and without limitation. The vehicle door 14 includes an edge face 15, inside and outside door handles 16, 17, a lock knob 18, with at least one hinge pivotally fixing the door 14 to the vehicle body 12. A latch assembly 20 is positioned or sealing affixed against an inner surface of the edge face 15. The latch assembly 20 includes a latch mechanism having a pivotal latch (i.e. ratchet) member 24 (FIGS. 2 and 3) that is releasably engageable with a striker 28 mounted on the vehicle body 12 to releasably hold the vehicle door 14 in a closed position. The lock knob 18 (optional) is shown and provides a visual indication of the lock state of the latch assembly 20 and may be operable to change the lock state between an unlocked state and a locked state. At least one of the handles 16, 17 is operably connected to the latch assembly 20 via a wire or release cable 21, such as a Bowden cable, by way of example and without limitation, for facilitating actuation of latch assembly 20 via intended (selective) operation of the handles 16, 17. For example release cable 21 may be another type of cable, such as a cinch cable, or a lock or unlock cable, or the like. Specifically, the release cable 21 operably connects one of handles 16, 17 to the functionally moveable latch member release component 24 of the latch assembly 20 for opening or unlatching the latch assembly 20 (i.e. for releasing striker 28 from latched engagement with the latch member 24) to open the vehicle door 14. As is detailed hereafter, the latch assembly 20 is constructed and otherwise configured to inhibit the ingress of water therein, thereby eliminating the potential for jamming of functional internal components due to freezing and further inhibiting the onset of corrosion of functional internal components. To facilitate the inhibition of water ingress, the latch assembly 20 includes a water shield 19 and at least one or more seal members to inhibit the ingress of water between an interface of a housing 22 and cover 23 of the latch assembly 20 and to inhibit the ingress of water into a cavity 27 containing internal latch components between openings in the housing 22 and/or cover 23, such as openings 25 formed to allow the wires and/or cables 21 to pass therethrough. Accordingly, the latch assembly 20 is able to function as intended, for an extended useful life, without concern of malfunction resulting from phenomenon related to the ingress of water.

In general, the closure panel 14 (e.g. occupant ingress or egress controlling panels such as, but not limited to, vehicle doors and lift gates/hatches) is connected to vehicle body 12 via one or more hinges (e.g. for retaining closure panel 14). Closure panel 14 can be referred to as a partition or door, typically hinged, but sometimes attached by other mechanisms such as tracks, in front of an opening which is used for entering and exiting vehicle 10 interior by people and/or cargo. It is also recognized that closure panel 14 can be used as an access panel for vehicle systems such as engine compartments and traditional trunk compartments of automotive type vehicles 10. It is to be recognized that the hinge(s) can be configured as a biased hinge that is operable to bias closure panel 14 toward the open position and/or toward the closed position, as desired. The vehicle body 12 can include the mating latch component 28 (e.g. striker) mounted thereon for coupling with a respective functional latching component 24 (i.e. the ratchet) of latch assembly 20 mounted on closure panel 14. Alternatively, latch assembly 20 can be mounted on vehicle body 12 and the mating latch component 28 can be mounted on the closure panel 14 (not shown, but will be readily understood by one skilled in the art).

Movement of the closure panel 14 (e.g. between the open and closed positions) can be electronically and/or manually operated, where power assisted closure panels 14 can be found on minivans, high-end cars, or sport utility vehicles (SUVs) and the like. As such, it is recognized that movement of the closure panel 14 can be manual or power assisted during intended operation of closure panel 14, for example, between fully closed (e.g. locked or latched) and fully open positions (e.g. unlocked or unlatched); between locked/latched and partially open positions (e.g. unlocked or unlatched); and/or between partially open (e.g. unlocked or unlatched) and fully open positions (e.g. unlocked or unlatched). It is recognized that the partially open position of the closure panel 14 can also include a secondary lock position.

In terms of vehicles 10, closure panel 14 may be a driver/passenger door, a lift gate, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or toward) the opening in body 12 of vehicle 10. Also contemplated are sliding door embodiments of closure panel 14 and canopy door embodiments of closure panel 14, such that sliding doors can be a type of door that open by sliding horizontally or vertically, whereby the door is either mounted on, or suspended from a track that provides for a larger opening. Canopy doors are a type of door that sit on top of the vehicle and lift up in some way, to provide access for vehicle passengers via the opening (e.g. car canopy, aircraft canopy, etc.). Canopy doors can be connected (e.g. hinged at a defined pivot axis and/or connected for travel along a track) to the body 12 of the vehicle 10 at the front, side or back of the door, as the application permits. It is recognized that body 12 can be represented as a body panel of vehicle 10, a frame of vehicle 10, and/or a combination frame and body panel assembly, as desired.

With regard to the latch assembly 20, FIG. 2 is a plan view showing some of the functional internal latch components of one possible embodiment of latch assembly 20 in accordance with the disclosure, while those possessing ordinary skill in the art of vehicle latches will readily appreciated other latch arrangements. The latch assembly 20 includes the housing 22 bounding, at least in part, the internal cavity 27 in which the primary ratchet 24 (which may, for convenience, be referred to simply as the ratchet 24) is pivotally mounted via a primary ratchet pin joint for rotation about a primary ratchet pivot axis 26 mounted in the housing 22. The ratchet 24 pivots between a fully closed position (FIG. 2) wherein the striker 28 is captured in a slot 29 by a hook 30 of the ratchet 24, and an open position (FIG. 3) wherein the striker 28 is not trapped by the hook 30 and is free to move out of the slot 29 presented by the ratchet 24. In the view shown in FIG. 2 the ratchet 24 rotates clockwise to move from the closed position to the open position.

The ratchet 24 is biased towards the open position via a ratchet biasing member 31. The biasing member 31 may be any suitable type of biasing member, such as, for example, a torsion spring. A striker bumper 32 is mounted in the housing 22 (underneath the ratchet 24) to cushion against the striker force of impact and a ratchet bumper 34 is also mounted about a post 36 provided in the housing 22 to cushion against the ratchet force of impact.

An auxiliary ratchet 44 is also pivotally mounted in the internal cavity 27 of housing 22 via an auxiliary ratchet pin joint 46 for movement about an auxiliary ratchet pivot axis 46. A primary pawl 47 is pivotally mounted to the auxiliary ratchet 44 via a primary pawl pin joint 49 for movement about a primary pawl pivot axis. The auxiliary ratchet 44 is movable between a primary pawl enabling position (FIG. 2) and a primary pawl disabling position (FIG. 3). In the primary pawl enabling position the auxiliary ratchet 44 permits the primary pawl 47 to move to a ratchet locking position to hold the ratchet 24 in the closed position, as shown in FIG. 2. In the primary pawl disabling position (FIG. 3) the auxiliary ratchet 44 prevents movement of the primary pawl 47 to the ratchet locking position, and instead holds the primary pawl 47 in a ratchet release position, as discussed in greater detail below. In the view shown in FIG. 2, the auxiliary ratchet 44 rotates clockwise to reach the primary pawl disabling position.

The auxiliary ratchet 44 includes a cylindrical bore 48 which receives a cylindrical stub of the primary pawl 47 for pivotally mounting the primary pawl 47 into the bore 48, thereby forming pin joint 49 of the auxiliary ratchet 44. This provides a simple means for mounting the primary pawl 47, which may be formed from a simple stamped or sintered metal piece.

The auxiliary ratchet 44 also includes a leg 50 which optionally, as shown in FIG. 2, terminates in an anvil 52 having a check shoulder 54 and a cam lip 56. The auxiliary ratchet 44 may be encapsulated with an elastomeric material and features an optional hollow 58 (FIG. 2) so as to provide an elastically deformable band 60 for contacting and absorbing impact against the ratchet 24.

An auxiliary ratchet biasing member 61 located on the opposing side of the housing 22 biases the auxiliary ratchet 44 to the primary pawl disabling position. Only the hub portion of the auxiliary ratchet biasing member 61 is shown in FIG. 2, (and is shown in stippled lines), for simplicity. The biasing member 61 may include a first tang (not shown) that abuts a capstan of pin joint 46 and a second tang which cooperates with a fork (not shown) in the auxiliary ratchet 44 via a slot (not shown) formed in the housing 22.

Referring back to FIG. 2, the primary pawl 47 includes a check arm 68. In the ratchet locking position the check arm 68 stops the ratchet 24 from opening by abutting contact with a surface of the ratchet 24. The primary pawl 47 rotates clockwise to move to the ratchet release position.

The angular sweep of the check arm 68 is limited on one side by an edge 63 in the auxiliary ratchet 44 and on the other side by the auxiliary ratchet leg 50. A proboscis bumper 72 formed from an encapsulation of the primary pawl 47 may be provided to cushion impact of check arm 68 against the auxiliary ratchet leg 50. An extension 33 of the striker bumper 32 may be provided to reduce or cushion impact of check arm 68 against the auxiliary ratchet edge 63.

The primary pawl 47 is biased towards the ratchet locking position by a primary pawl biasing member 74 wrapped around a post 76 provided in the anvil 52 of the auxiliary ratchet 44. One tang (not visible in FIG. 2) of the biasing member 74 rides against the auxiliary ratchet leg 50, and another tang 78 abuts the check arm 68 of the primary pawl 47. As the biasing member 74 is mounted to the auxiliary ratchet 44 rather than the fixed housing 22, the biasing forces on the primary pawl 47 will not vary appreciably as the auxiliary ratchet 44 rotates. In embodiments wherein the post 76 is not provided, the biasing member 74 may be provided on the housing 22 or at some other location on the auxiliary ratchet 44.

As shown in FIG. 3, ratchet 24 features primary and secondary locking surfaces 80 and 82 that interact with the check arm 68 (FIG. 2) of the primary pawl 47. The primary locking surface 80 provides a fully closed position for the ratchet 24 in which the striker 28 is securely ensconced in the slot 29 of the ratchet 24 such that the vehicle door 14 is completely closed and the door seals are compressed. The secondary locking surface 82 provides a partially closed and locked position of the ratchet 24 wherein the striker 28 is loosely secured in the slot 29 of the ratchet 24 such that the vehicle door 14 is locked but not completely closed against the door seals.

A secondary pawl 84 is pivotally mounted in the housing 22 via a secondary pawl pin joint for movement about a secondary pawl pivot axis 86 for movement between an auxiliary ratchet holding position where the secondary pawl 84 holds the auxiliary ratchet 44 in the primary pawl enabling position, as shown in FIG. 2, and an auxiliary ratchet release position in which the secondary pawl 84 permits the auxiliary ratchet 44 to move to the primary pawl disabling position, as shown in FIG. 3. In the view shown in FIG. 2 the secondary pawl 84 rotates counterclockwise to reach the auxiliary ratchet release position. The secondary pawl 84 includes a hook shoulder 88 for engaging the auxiliary ratchet check shoulder 54. The secondary pawl 84 is biased towards the auxiliary ratchet holding position by a secondary pawl biasing member. The secondary pawl biasing member may be any suitable type of biasing member, such as, for example, a torsion spring.

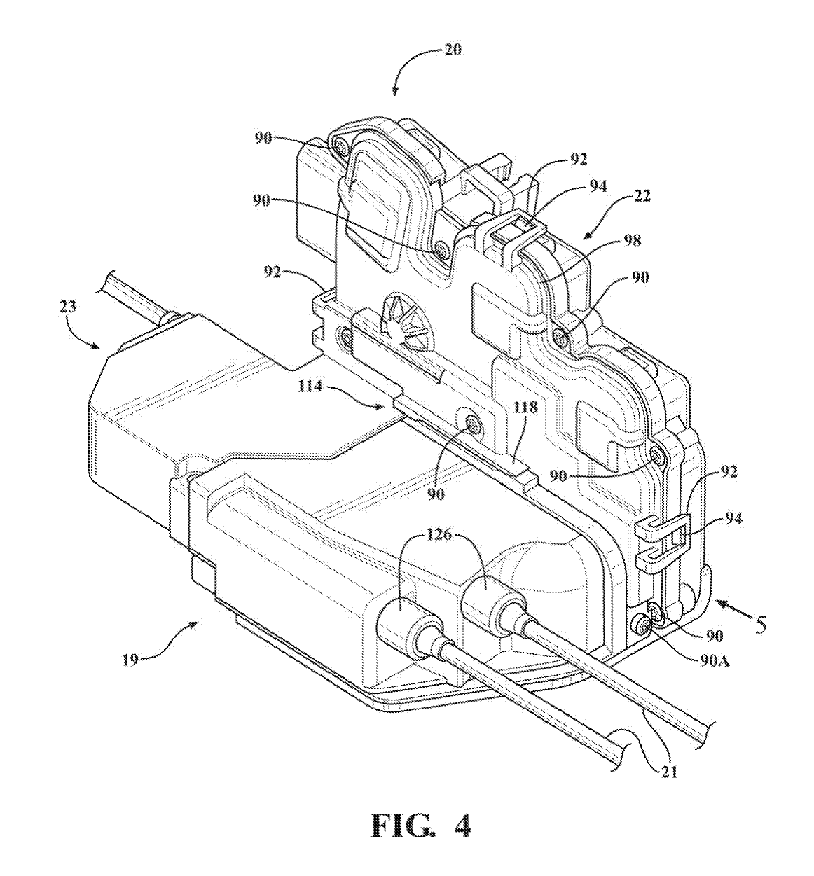

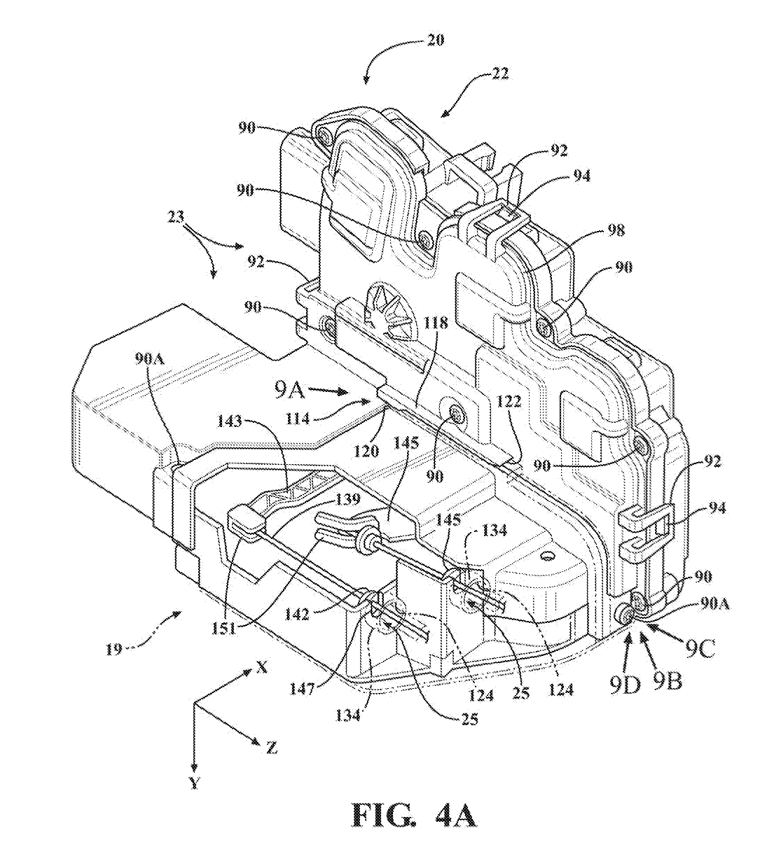

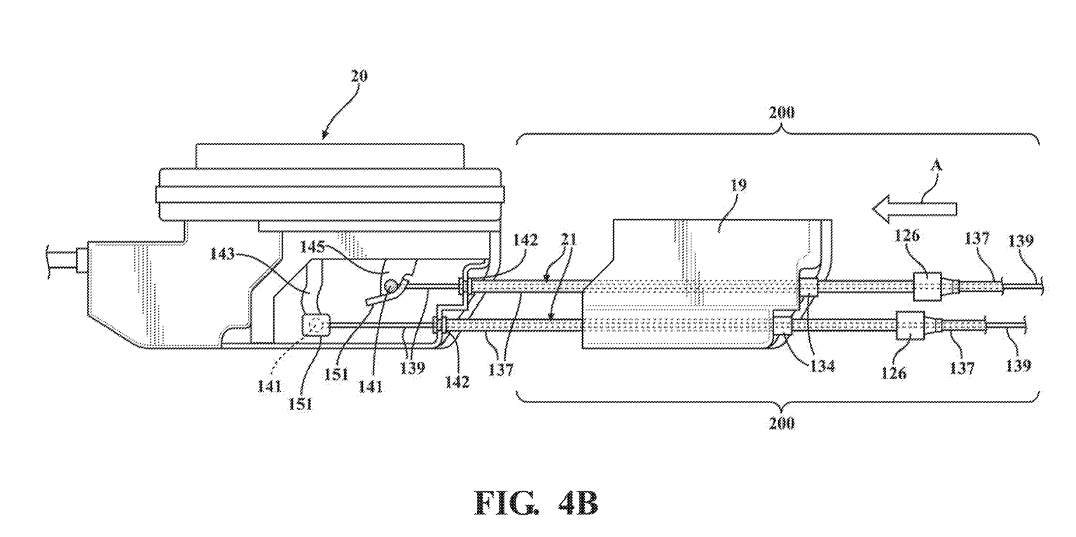

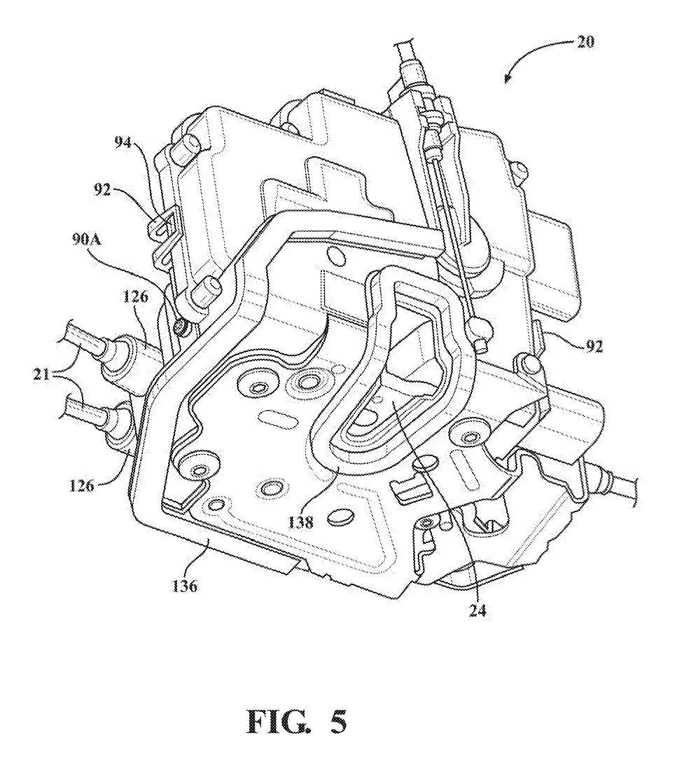

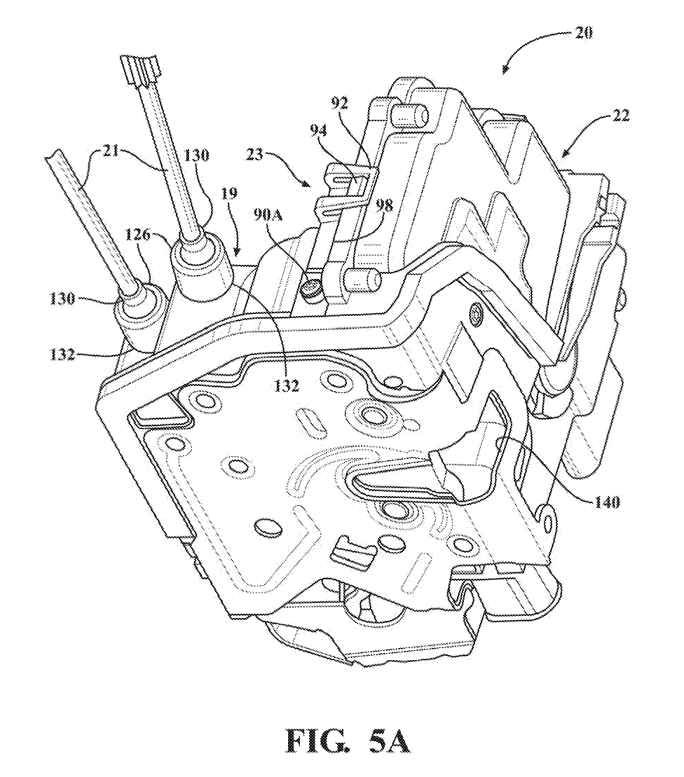

Referring to FIGS. 4, 4A, 5 and 5A, the water shield 19, housing 22 and cover 23 of the latch assembly 20 are shown assembled together to establish a water-tight sealed attachment with one another. Illustratively, the housing 22 and cover 23 of the latch assembly 20 may be manufactured of a plastic material formed by a plastic injection molding process, by way of example and without limitation, but may also be formed from, or in combination with, for example, a metal material, a carbon fiber material, or other like materials. Further, the release cables 21 are shown in coupled relationship to the water shield 19 of latch assembly 20 to establish a water-tight sealed attachment therewith. Accordingly, water is inhibited from entering the latch assembly 20, thereby ensuring the internal components function as intended and resist corrosion, regardless of external environmental conditions/temperature.

Now referring to FIG. 4B, in addition to FIG. 4A, illustrated is the water shield 19, housing 22 and cover 23 of the latch assembly 20 in a pre-assembled state. Each of the cables 21 include a sheath 137 for slidably housing a wire 139. The terminal end of the sheath 137 includes an annular flange 142 configured for sliding engagement and retention within a receptacle or notch 147, illustratively shown as a U-shaped notch, formed in the housing 22. The terminal end of each wire 139 illustratively includes a ball 141 for engagement and retention with a receiving socket 151 of an internal latch component, such as an inside lock lever 143 operatively connected to a lock mechanism to lock or unlock the latch assembly 20, and an outside release lever 145 operatively coupled to the secondary pawl 84 for actuating secondary pawl 84 to move the primary pawl 47 to a ratchet release position when the inside or outside handle 16, 17 is respectively moved. Prior to assembly of the water shield 19 with the housing 22 and cover 23, each of the annular flanges 142 of the sheath 137 are engaged with one of the housing receptacles 147 and the ball 141 of each wire 139 is connected to the release levers 143, 145. The seal members 126 are slidably positioned about the sheath 137, and each sheath 137 is slidably received within one of the openings 124. During assembly, the cover 19 is slid into engagement along direction arrow A into engagement with the housing 22, and the threaded fasteners 90A are secured in place, to there by engage/compress the seal member 106. The seal members 126 are slidably engaged with the annular nipples 134. Such an illustrative assembly process allows the cables 21 to be easy connected with the levers 143, 145, and the water shield 19 to be subsequently easily installed after the cables 21 have been connected to the levers 143, 145, for example the water shield 19 can be slid into the assembled state with reduced assembly time and all the while ensuring a robust seal is formed between the water shield 19 and the housing 22 and cover 23. In an embodiment, the cables 21 may be provided as a cable/water shield assembly 200 for assembly with the latch assembly 20 whereby the seal members 126 are slidably positioned about the sheath 137 and each cable 21 is slidably received within one of the openings 124 prior to shipping and assembly with the latch assembly 20, with the cable/watershield assembly 200 being shippable separately and assembled with the latch assembly 20 on-site and just in time.

The housing 22 and cover 23 are shown attached to one another to enclose at least a portion or the entirety of cavity 27 via a fastening mechanism, and are shown, by way of example and without limitation, as being securedly attached to one another via a plurality of threaded fasteners 90 and coupled snap or hook members, shown as fingers 92 of the cover 23 being hooked about tabs 94 of the housing 22. It will be appreciated by those possessing ordinary skill in the art that any suitable fastening mechanism can be used, and that one or more of the aforementioned fastening mechanism can be used alone or in combination with one another. Accordingly, one will appreciate that the threaded fasteners 90, fingers 92 and tabs 94 could be used alone, eliminated or provided in reverse relation.

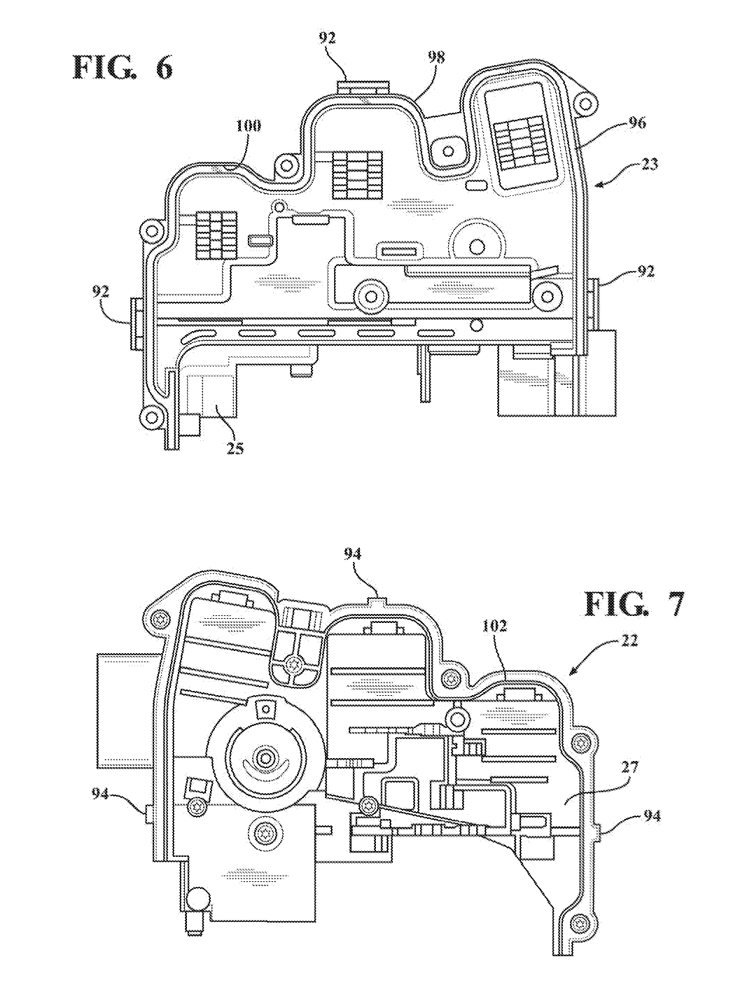

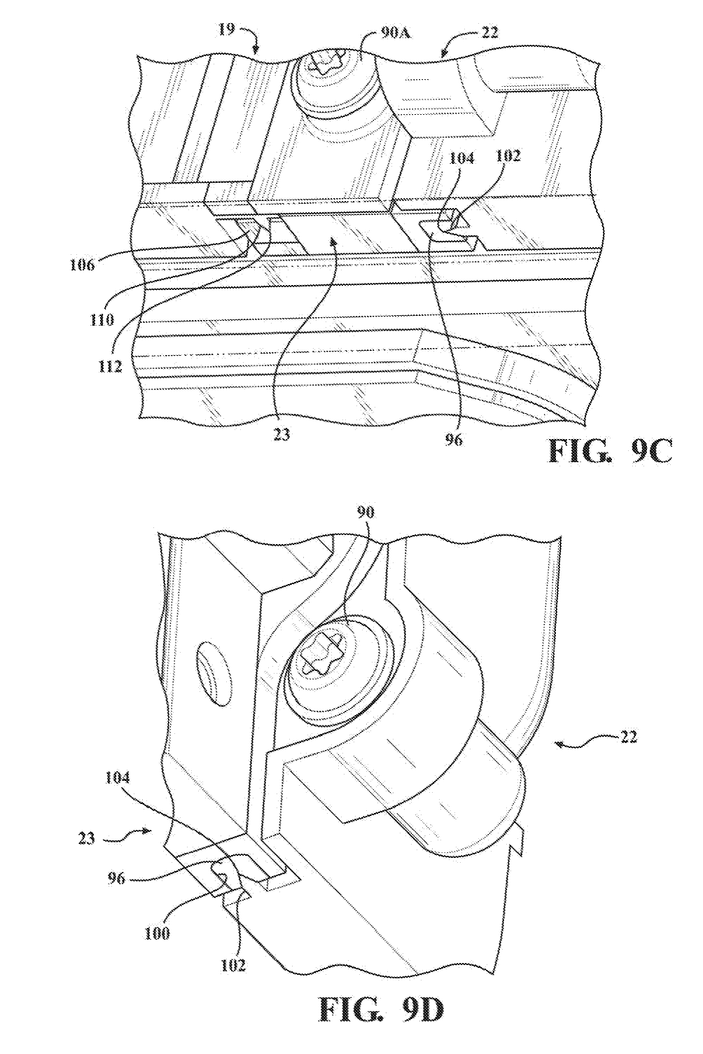

Water is prevented or at least greatly inhibited from entering internal cavity 27 between an interface of the housing 22 and the cover 23 via at least one seal member 96. As best shown in FIG. 6, the at least one seal member 96 can be provided as a single seal member, though it is to be recognized that a plurality of seal members could be included. The seal member 96 is shown as extending immediately adjacent and about, at least in part, an outer periphery 98 of the cover 23. The seal member 96 can be affixed to the cover 23 as desired, and is shown as being disposed in a recessed channel 100 (FIGS. 6 and 9D). The seal member 96 can be sized for an interference fit within the channel 100 such that the interference fit negates the need for any additional coupling mechanisms, though a supplemental or redundant mechanism can be used, such as any suitable adhesive, by way of example and without limitation. It will be appreciated by those skilled in the art that the seal member 96 could be fixed to the cover 23 without a channel, such as via an adhesive or otherwise. The seal member 96 can be provided as any suitable compliant sealing material, such as for example, rubber or any other elastomeric material.

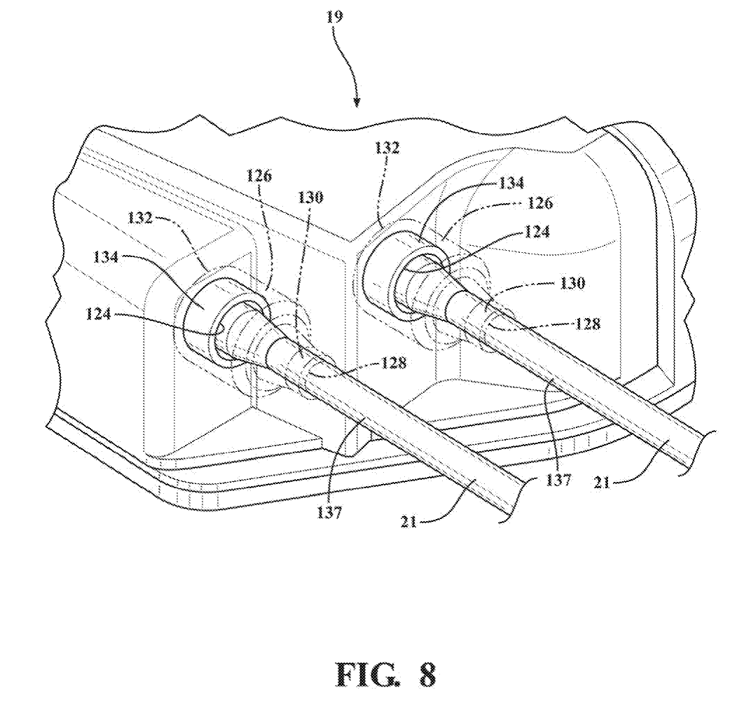

To further facilitate forming a water-tight seal, the opposing member brought into abutment with the seal member 96, shown as the housing 22, can be provided with a continuous outwardly extending rigid protrusion or rib, also referred to as raised seal bead or simply as bead 102 (FIGS. 7, 9C and 9D) configured to abut the seal member 96 to establish a seal therewith. The bead 102 can be formed converging to a terminal edge 104 configured to indent and extend into compressed engagement with the seal member 96, thereby causing the seal member 96 to deform elastically about the bead 102 to establish a fluid-tight seal. The terminal edge 104 can be formed to extend continuously along the bead 102 to establish a non-interrupted water-tight seal along the full or substantially full length (meaning slightly less than the entire length, but a vast majority of the length) of the bead 102 and seal member 96. The bead 102 is preferably sized for a clearance receipt within the recess channel 100, thereby allowing the seal member 96 to flow elastically outwardly therefrom and about opposite sides of the bead 102, if need be, to establish a reliable fluid-tight seal.

It is to be recognized that the seal member 96 could be fixedly attached to the housing 22 and the mating bead 102 could be formed on the cover 23, for example as an integrally molded piece through plastic molded injection processes, if desired. Accordingly, the locations of the seal member 96 and the bead 102 are interchangeable, as desired.

Water is further inhibited from entering the internal cavity 27 beneath cover 23 at least in part due to the incorporation of the water shield 19. The water shield 19 is attached to the cover 23 and brought into sealed relation therewith via at least one seal member 106 (FIGS. 9A-9C) forming a fluid-tight seal therebetween. The seal member 106 can be affixed to the cover 23 as desired, and is shown as being disposed in a recessed channel 108 (FIG. 9B), such as in a close, snug fit, by way of example and without limitation. As with the seal member 96 discussed above, any suitable adhesive can be used, if needed, to facilitate fixing the seal member 96 to the cover 23.

To further facilitate forming a water-tight seal, the opposing member brought into abutment with the seal member 106, shown as the water shield 19, can be provided with a continuous outwardly extending rigid protrusion or rib, also referred to as raised bead or simply as bead 110 (FIGS. 9A-9C) configured to abut and elastically compress the seal member 106 to establish a fluid-tight, leak-proof seal therewith. The bead 110 can be formed converging to a terminal edge 112 configured to indent and extend sealingly into compressed engagement with the seal member 106, thereby forming a fluid-tight seal there against, as discussed above for bead 102. The terminal edge 112 can be formed to extend continuously to establish a non-interrupted water-tight seal along the full or substantially full length (meaning slightly less than the entire length, but a vast majority of the length) of the bead 110. The bead 110 is preferably sized for clearance receipt within the recessed channel 108, thereby allowing the seal member 106 to flow elastically outwardly therefrom and about opposite sides of the bead 110, if need be, to establish a reliable fluid-tight seal.

It is to be recognized that the seal member 106 could be fixedly attached to the water shield 19 and the mating bead 110 could be formed on the cover 23, if desired. Accordingly, the locations of the seal member 106 and the bead 110 are interchangeable, as desired.

The water shield 19 and cover 23 are shown attached to one another via a fastening mechanism, and are shown, by way of example and without limitation, as being securedly attached to one another via at least one or a plurality of threaded fasteners 90A and a slide mechanism 114 (shown enlarged in FIG. 9A). The slide mechanism 114 is shown as including a raised cam surface 116 on the water shield 19 and a ledge or detent 118 on the cover 23, wherein the cam surface 116 and detent 118 are configured to interact and engage one another to facilitate bringing the bead 110 of the water shield 19 slidingly into a snug, compressing water-tight fit with the seal member 106 affixed to the cover 23 as cover 23 is brought into sliding engagement with housing 22 along a direction as illustrated by arrow A in FIG. 4B. Illustratively, the direction represented by arrow A corresponds to a longitudinal axis of cables 21 extending relative to the housing 22 when assembled (i.e. flanges 142 engaged with notches 147) therewith such that the sliding movement of the water shield 19 there along the cables 21 is not hindered by the orientation of the assembled cables 21 relative to the housing 22. To facilitate sliding the cam surface 116 beneath the detent 118, the cam surface 116 and detent 118 can be provided with respective inclined first lead-in surfaces 120, 122 and with respective inclined second lead-in surfaces 121, 123, such that the lead-in surfaces 120, 122; 121, 123 (FIG. 9A) cause the cam surface 116 to slide freely beneath the detent 118, whereupon the water shield 19 is caused to be slidingly compressed downwardly to elastically deform the seal member 106 with the edge 112 of the bead 110, thereby forming a water-tight, leak-proof seal therebetween upon fully sliding the water shield 19 into position on the cover 23, as shown in FIGS. 9A and 9B. It will be recognized that the lead-in surfaces 120, 122 engage each other first to cause an initial first compression of the seal member 106 by the bead 110, and then the lead-in surface 120 engages the lead-in surface 123, while the lead-in surface 121 engages the lead-in surface 122 to cause a second, greater compression of the seal member 106 by the bead 110. Accordingly, a two-stage compression of the seal member 106 by the bead 110 is performed to perfect a reliable water-tight seal therebetween. It will be appreciated that a single stage or additional stages could be employed, as desired. Optionally, the compression of the seal member 106 may be gradual during the sliding engagement of the water shield 19 with the cover 23, or the compression or the majority of the compression may occur towards the end of the sliding travel engagement of the water shield 19 with the cover 23 to ensure the seal member 106 is not damaged or laterally stretched by the sliding action of the bead 110 thereon. Then, upon sliding the water shield 19 into a final assembled position, wherein at least a portion of the water shield 19 overlies the cover 23 to further inhibit the ingress of water (particularly through the cable through openings 25 formed in the cover 23; shown best in FIG. 4A), one or more fasteners 90A can be assembled to maintain the water shield 19 in sealed attachment with the cover 23 (FIGS. 9B and 9C).

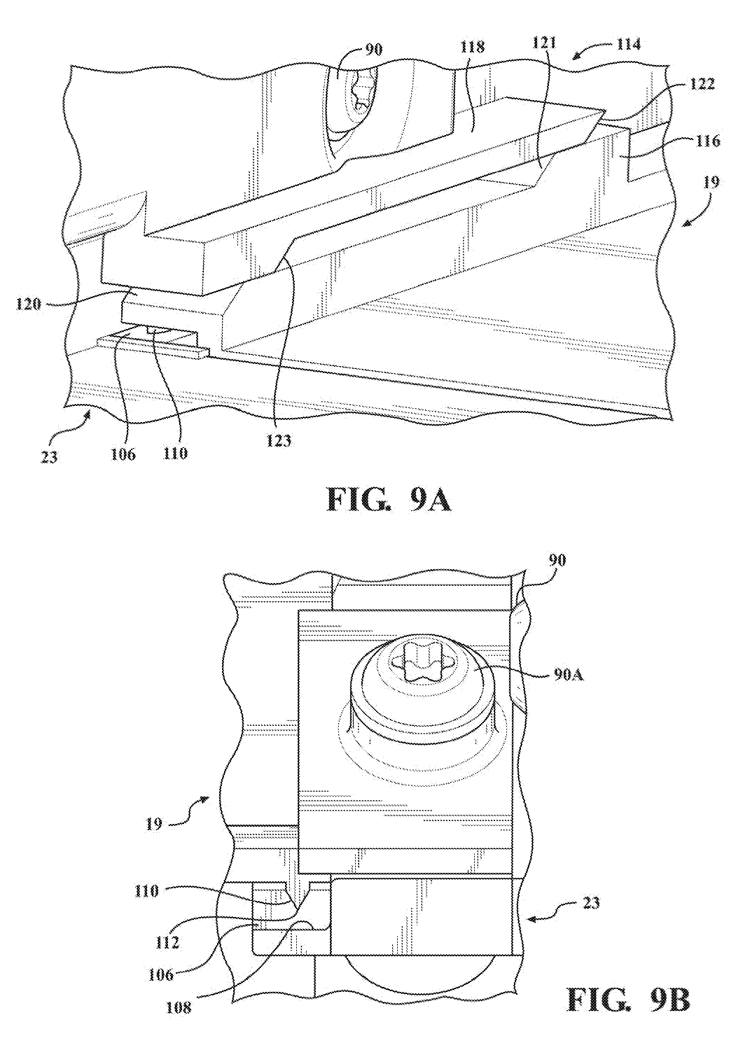

The water shield 19 further inhibits water from entering the internal cavity 27 of latch assembly 20 in a coupling region of the release cables 21. The water shield 19, as discussed above, is brought into water-tight sealed relation with the cover 23, and the water shield 19 further includes openings 124 (FIGS. 4A and 8) sized for receipt of the release cables 21 therethrough. As shown in FIGS. 4, 5, 5A and 8, seal members 126 are provided to form a water-tight seal about the openings 124 to prevent water from passing into and through the openings 124, with the seal members 126 being configured as annular members, such as grommets or the like, to establish a fluid-tight seal about the release cables 21 and about the openings 124. The seal members 126 have through bores 128 (FIG. 8) sized for a snug, interference fit with an outer surface of the release cables 21, and being elastic, first ends 130 of the seal members 126 form a water-tight seal about the release cables 21 upon being slightly stretched thereover. Further, the through bores 128 extend to second ends 132 sized to form a water-tight seal with the water shield 19, wherein the second ends 132 are shown as being sized for a snug, interference fit about annular bosses or annular nipples 134 of the openings 124. As such, upon assembling and coupling the release cables 21 to their respective internal latch component of the latch assembly 20, such as to a pawl, by way of example and without limitation, the seal members 126 can be simply slid along the release cables 21 and brought into sealed attachment about the nipples 134. Such as seal can prevent water which may travel along the surface of the cable 21 from penetrating through the openings 124 and into the internal cavity 27 thereof. Such configuration permits the ability to complete the assembling of the latch assembly 20 with the release cables 21 while ensuring a sealing of latch assembly 20 that is easy to establish i.e. the water shield 19 can be slid into sealed engagement with the housing cover 23.

Accordingly, with the housing 22 and cover 23 being brought into fluid-tight sealed relation with one another via the seal member 96; the water shield 19 and the cover 23 being brought into fluid-tight sealed relation with one another via the seal member 106, and the release cables 21 being brought into fluid-tight sealed relation with the water shield 19 via the seal members 126, the latch assembly 20 is assured of being waterproof, thereby preventing the ingress of water into the internal cavity 27 thereof.

Further yet, as shown in FIG. 5, one or more seal members 136, 138 can be provided to form a water-tight seal between the latch assembly 20 and the body in white surface (BIW), such as an inner surface of the door edge face 15, to which the latch assembly 20 is fixedly attached. The seal member 136 is shown as extending about at least a portion of the latch assembly surface that is brought into abutment with the BIW, and the seal member 138 is shown being annular and as extending about the periphery of an opening 140 (FIG. 5A) through which the striker 28 passes. As such, water is further prevented from ingress between the latch assembly 20 and the BIW, thereby further enhancing the protection against potential damage caused by water, such as from water freezing and/or corrosion.

While the above description constitutes a plurality of embodiments of the present invention, it will be appreciated that the present invention is subject to further modification and change without departing from the fair interpretation and intended meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a vehicle closure panel, comprising:
a housing having an internal cavity configured for receipt of internal latch components;
a cover attached to said housing to enclose at least a portion of said internal cavity;
at least one release cable configured for operable connection to at least one of the internal latch components;
a water shield attached to said cover and having at least one opening sized for receipt of said at least one release cable therethrough; and
at least one seal member configured to form a water-tight seal between at least one of said housing and said cover, said water shield and said cover, and said at least one opening and said at least one release cable.

2. The latch assembly of claim 1, wherein said at least one seal member includes a first seal member that provides a water tight seal between said housing and said cover.

3. The latch assembly of claim 2, wherein said first seal member is attached to one of said housing and said cover, and the other of said housing and said cover has a raised seal bead brought into compressed engagement with said first seal member.

4. The latch assembly of claim 2, wherein said at least one seal member includes a second seal member that provides a water tight seal between said water shield and said cover.

5. The latch assembly of claim 4, wherein said second seal member is attached to one of said water shield and said cover, and the other of said water shield and said cover has a raised seal bead brought into compressed engagement with said second seal member.

6. The latch assembly of claim 5, wherein one of said cover and said water shield has a cam surface and the other of said cover and said water shield has a detent, said cam surface and said detent being configured to bring at least a portion of said raised seal bead into compressed engagement with said second seal member.

7. The latch assembly of claim 6, wherein said cam surface and said detent each have at least one lead-in surface to facilitate bringing said raised seal bead into sliding compressed engagement with said second seal member.

8. The latch assembly of claim 4, wherein said at least one seal member includes a third seal member that provides a water tight seal between said at least one opening and said at least one release cable.

9. The latch assembly of claim 8, wherein said third seal member is an annular member having a through bore sized for an interference fit about said at least one release cable and sized for an interference fit about an opening in said water shield.

10. The latch assembly of claim 1, wherein said at least one seal member provides a water tight seal between said water shield and said cover and wherein one of said cover and said water shield has a cam surface and the other of said cover and said water shield has a detent, said cam surface and said detent being configured to bring at least a portion of a raised seal bead into compressed engagement with said at least one seal member.

11. A vehicle closure panel having a closure latch assembly, comprising:
a housing having an internal cavity configured for receipt of internal latch components;
a cover attached to said housing to enclose at least a portion of said internal cavity;
at least one release cable configured for operable connection to at least one of the internal latch components;
a water shield attached to said cover and having at least one opening sized for receipt of said at least one release cable therethrough; and
at least one seal member configured to form a water-tight seal between at least one of said housing and said cover, said water shield and said cover, and said at least one opening and said at least one release cable.

12. The vehicle closure panel of claim 11, wherein said at least one seal member includes a first seal member that provides a water tight seal between said housing and said cover.

13. The vehicle closure panel of claim 12, wherein said first seal member is attached to one of said housing and said cover, and the other of said housing and said cover has a raised seal bead brought into compressed engagement with said first seal member.

14. The vehicle closure panel of claim 12, wherein said at least one seal member includes a second seal member that provides a water tight seal between said water shield and said cover.

15. The vehicle closure panel of claim 14, wherein said second seal member is attached to one of said water shield and said cover, and the other of said water shield and said cover has a raised seal bead brought into compressed engagement with said second seal member.

16. The vehicle closure panel of claim 15, wherein one of said cover and said water shield has a cam surface and the other of said cover and said water shield has a detent, said cam surface and said detent being configured to bring at least a portion of said raised seal bead into compressed engagement with said second seal member.

17. The vehicle closure panel of claim 16, wherein said cam surface and said detent each have at least one lead-in surface to facilitate bringing said raised seal bead into sliding compressed engagement with said second seal member.

18. The vehicle closure panel of claim 14, wherein said at least one seal member includes a third seal member that provides a water tight seal between said at least one opening and said at least one release cable.

19. The vehicle closure panel of claim 18, wherein said third seal member is an annular member having a through bore sized for an interference fit about said at least one release cable and sized for an interference fit about an opening in said water shield.

20. The vehicle closure panel of claim 11, wherein said at least one seal member provides a water tight seal between said water shield and said cover and wherein one of said cover and said water shield has a cam surface and the other of said cover and said water shield has a detent, said cam surface and said detent being configured to bring at least a portion of a raised seal bead into compressed engagement with said at least one seal member.
